(19) United States
(12) Patent Application Publication
(10) Pub. No.: US 2012/0081542 A1
(43) Pub. Date: Apr. 5, 2012

(54) OBSTACLE DETECTING SYSTEM AND METHOD

(75) Inventors: Jung Hee SUK, Daejeon (KR); Chun Gi Lyuh, Daejeon (KR); Ik Jae Chun, Daejeon (KR); Wook Jin Chung, Andong (KR); Jeong Hwan Lee, Daegu (KR); Jae Chang Shim, Andong (KR); Tae Moon Roh, Daejeon (KR)

(73) Assignees: ANDONG UNIVERSITY INDUSTRY-ACADEMIC COOPERATION FOUNDATION, Andong (KR); Electronics and Telecommunications Research Institute, Daejeon (KR)

(21) Appl. No.: 13/179,122

(22) Filed: Jul. 8, 2011

(30) Foreign Application Priority Data
Oct. 1, 2010 (KR) 10-2010-0095838

(51) Int. Cl. H04N 7/18; G06K 9/00

(52) U.S. Cl. 348/139; 382/103; 348/E07.085

(57) ABSTRACT

The obstacle detecting system includes a first image acquiring unit which acquires first image information by selectively receiving a laser beam emitted from at least one laser source toward a road surface at a target distance; a second image acquiring unit which acquires an image of actual surroundings as second image information; an image recognizing unit which recognizes an image of an obstacle by performing 3-D image recognition signal processing on line information of the laser beam using the first image information, and recognizes a pattern of the obstacle by performing pattern recognition signal processing on the second image information; and a risk determining unit which determines a possibility of collision due to presence of the obstacle within the target distance by classifying the recognized obstacles according to whether or not the image-recognized obstacle is matched with the pattern-recognized obstacle.

### CROSS-REFERENCE TO RELATED APPLICATION

This application claims priority to and the benefit of Korean Patent Application No. 10-2010-0095838, filed Oct. 1, 2010, the disclosure of which is incorporated herein by reference in its entirety.

### BACKGROUND

1. Field of the Invention

The present invention relates to an obstacle detecting system and method for use in vehicles. More specifically, the present invention relates to a system and method for detecting an obstacle on a road, which can detect the obstacle existing within a forward safety distance of a driving vehicle to determine risk level on the basis of image information about a projection image of a laser beam directed toward a road surface and image information about the actual surroundings.

2. Discussion of Related Art

Recently, with the development of image forming apparatuses such as cameras, an interest in information processing techniques using images has gradually increased. In particular, in the automotive industry, efforts have been continuously made to perform advanced vehicle control using images that are obtained in real time from a camera built in the front or rear of the vehicle, thereby preventing head-on and rear-end collisions. If the presence or positions of objects, such as other vehicles, pedestrians or animals, which can be a hindrance to driving, in front of the vehicle, is known, this can not only prevent serious traffic accidents but also be utilized as driving guides for disabled persons. Major automobile manufacturing companies in developed countries are studying advanced vehicle control devices. Also, studies are being vigorously made of development of various sensors and devices for preventing traffic accidents caused by negligence of a driver during driving, and development of effective algorithms for making efficient use of them.

Obstacle detecting methods used in recent years include methods for detecting a distance from a vehicle to a front object by transmitting and receiving radar signals or laser signals, and methods for detecting a distance from a vehicle to a front object based on 3-D image information which is obtained from stereo cameras. In addition, a control method for preventing a vehicle from colliding with an obstacle which is detected on the basis of information on the current speed detected by a speed detecting sensor of the vehicle has been introduced.

The methods using the radar signals or laser signals obtain point information using the sensors for transmitting and receiving the signals. Accordingly, there is a problem in that the shape of the detected object is not identified, and it is not easy to classify the obstacles. In particular, the technique of determining the presence or absence of the front object using a laser radar or laser distance measuring appliance, or detecting a front vehicle using a means for measuring a distance from the vehicle to the front object to prevent the collision is effective on a straight road. However, because of the linearity of the laser, it is difficult to apply the technique to a curved road.

In addition, several techniques applied to the vehicles of obtaining 3-D image information of the road surface or the like using a stereo camera system or a laser beam scanning system have been disclosed. The method using the stereo cameras utilizes images from two 2-D cameras, but substantially includes the problems associated with the forward monitoring technology using the camera image according to the related art. That is, since the obstacle is recognized on the screen including a background in the process of recognizing the pattern based on the image obtained from the cameras, there is a problem in that the recognition of the obstacle is sensitively varied depending upon day and night or illumination variation.

Meanwhile, a technique of measuring a 3-D shape of an object by a non-contact method which emits and scans a linear laser beam onto the object to be monitored has been disclosed. Such a shape measuring technique can express 3-D information on the shape of the object using the signal processing means, which is known as optical triangulation, as the shape of computer data. However, there is a problem in that, if the signal process is executed in real time and then is used to control the collision protection of the driving vehicle, a high-performance computing performance is required. In addition, a technique of recognizing the image information pattern should be added so as to recognize the obstacle and thus to prevent the collision on the basis of the 3-D image information obtained from the means, but it is not easy to obtain the distance information between the vehicle and the front vehicle or leftward or rightward moving information at the same time.

In addition, in the conventional technique of preventing the collision of the vehicles on the basis of the image only obtained by the cameras, a process of separating the background from the obstacle in the image should be added, some recognition errors for the obstacle happen according to the variation of illuminating environments such as day and night, and many verifying operations should be executed to succeed in the accurate pattern recognition. That is, the above-described technology is not sufficient for the means for quickly and accurately controlling the signal processing.

### SUMMARY OF THE INVENTION

The present invention is directed to quickly and effectively determine an obstacle present in a forward target distance of a moving means, by obtaining 3-D image information based on image information on a projection shape of a laser beam and obtaining 2-D image information on actual surroundings to identify movement of the obstacle and effectively detect or prevent collision risk or traffic lane deviation risk.

The present invention is also directed to simply and quickly classify and recognize a flat road and an obstacle by detecting the obstacle using a horizontal laser beam to effectively prevent collision risk or traffic lane deviation risk.

One aspect of the present invention provides an obstacle detecting system including: a first image acquiring unit which acquires first image information by selectively receiving a laser beam emitted from at least one laser source toward a road surface at a target distance; a second image acquiring unit which acquires an image of actual surroundings as second image information; an image recognizing unit which recognizes an image of an obstacle by performing a 3-D image recognition signal processing on line information of the laser beam using the first image information, and recognizes a pattern of the obstacle by performing a pattern recognition signal processing on the second image information; and a risk determining unit which determines a possibility of collision due to presence of the obstacle within the target distance by classifying the recognized obstacles according to whether or not the image-recognized obstacle is matched with the pattern-recognized obstacle.

Another aspect of the present invention provides obstacle detecting method including: scanning a laser beam on a road surface at a target distance from at least one laser source; selectively receiving the laser beam only to acquire first image information; acquiring an image of actual surroundings as second image information; recognizing a shape of the obstacle by performing 3-D image recognition signal processing on line information of the laser beam using the first image information; recognizing a pattern of the obstacle by performing pattern recognition signal processing on the second image information to; classifying the recognized obstacles by identifying the image-recognized obstacle is matched with the pattern-recognized obstacle or not; and determining a possibility of collision by identifying the obstacle is within the target distance or not, based on the classified result.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram illustrating the configuration of an obstacle detecting system according to an embodiment of the present invention;

FIG. 2 is a flowchart illustrating an obstacle detecting method according to an embodiment of the present invention;

FIG. 3 is a diagram illustrating one example of an obstacle detecting system according to one embodiment of the present invention which is applied to a vehicle;

FIG. 4 is a cross-sectional view taken along a line passing through a central portion of a vehicle which is parallel to a traffic lane in FIG. 3;

FIG. 5 is a diagram illustrating only an image of a projected laser beam among images acquired by a first image acquiring unit in the example of FIG. 4; and

FIG. 6 is a diagram illustrating one example of an obstacle detecting system according to one embodiment of the present invention which is applied to a vehicle.

### DETAILED DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Reference will now be made in detail to the exemplary embodiments of the present invention, examples of which are illustrated in the accompanying drawings, so that those skilled in the art can easily practice the present invention.

<Overall Configuration Of Obstacle Detecting System>

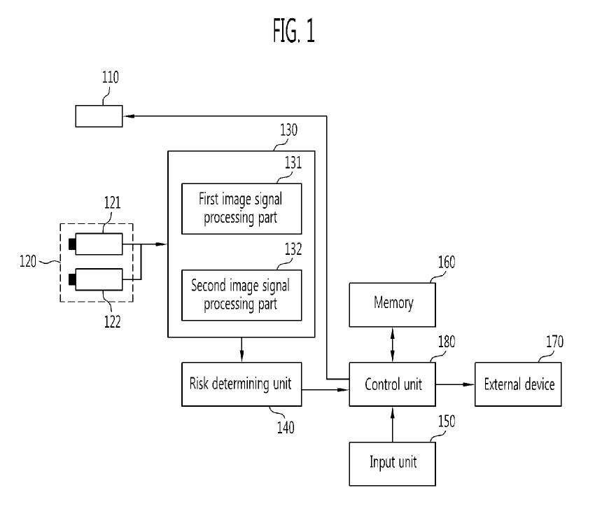

FIG. 1 is a block diagram schematically illustrating the overall configuration of an obstacle detecting system according to an embodiment of the present invention.

As shown in FIG. 1, an obstacle detecting system 100 according to the present invention includes a laser beam scanning unit 110, an image information acquiring unit 120, an image recognizing unit 130, and a risk determining unit 140. In addition, the obstacle detecting system 100 includes an input unit 150 manipulated by a user to input commands, a memory 160 serving as a storage device, an external device 170 built in a desired apparatus to which the present invention is applied, and a control unit 180 for controlling the overall operations of the above-described units.

According to the present invention, the image information acquiring unit 120, the image recognizing unit 130, the risk determining unit 140, the memory 160 and the control unit 150 may be program modules built in the system according to the present invention. These program modules may be included in, for instance, an operation system as applied program modules or other program modules, and may be physically stored in several known storage devices. In addition, these program modules can be stored in a remote storage device which can communicate with the system 100. Meanwhile, these program modules substantially include a routine, a sub routine, a program, an object, a component, and a data architecture, each of which executes a specific task to be described later or specific abstract data, but the present invention is not limited thereto.

The obstacle detecting system according to an embodiment of the present invention is mounted on a desired driving means, and performs a function of facilitating the safe movement of the driving means. Hereinafter, for the convenience of description, a case in which the obstacle detecting system according to an embodiment of the present invention is applied to a vehicle will be described.

The obstacle detecting system 100 according to an embodiment of the present invention scans a laser beam toward a road surface at a target distance. To this end, the obstacle detecting system 100 according to an embodiment of the present invention includes a laser source. As will be described later, since the laser beam radiated from the obstacle detecting system 100 should be projected widely on the road surface in front of the vehicle, the shape of the laser beam is preferably formed in the shape of a horizontal line. The optical technology of transforming a dotted laser beam generated by the laser source into the horizontal linear laser beam is known in the art, and thus the description thereof will be omitted herein.

Meanwhile, the laser beam scanning unit 110 may include two or more laser beam sources, which are installed at a predetermined interval in a vertical direction, or which are installed at the same position so as to have different beam scanning angles. Thus, two or more laser beams are cast in a forward direction of the vehicle. A pattern where each laser beam generated from the laser beam scanning unit 110 is cast will be described below.

The operation of the obstacle detecting system 100 is controlled by the control unit 180. The intensity of the laser beam or the scanning angle of the laser beam can be adjusted by a control signal output from the control unit 180. To this end, the laser beam scanning unit 110 and the control unit 180 are electrically connected to each other, and the laser beam scanning unit 110 includes a mechanical device (e.g., a motor and a control unit) for adjusting the angle of the laser beam. For example, the motor control unit may receive a downward angle of the laser beam which is set as a horizontal beam scanned towards the road surface, and adjust the downward angle of the laser beam, thereby adjusting the target distance. The expression “target distance” means the distance from the subject vehicle to a reaching point of the laser beam on the road surface. According to the present invention, the presence or absence of the obstacle within the target distance, the moving direction of the obstacle, and so on can be detected. For example, the target distance may be the minimum safety distance between the subject vehicle and the front vehicle, and may be set to have a greater value than a braking distance of the subject vehicle, or may be set according to a regulation standard, which will be described in detail hereinafter.

The image information acquiring unit 120 according to one embodiment of the present invention includes a first image acquiring part 121 for acquiring the image information from the laser beam emitted from the laser beam scanning unit 110 and projected on the road surface, and a second image acquiring part 122 for acquiring image information on actual surroundings in the vicinity of the subject vehicle, and transmits the image signal acquired by the first image acquiring part 121 and the second image acquiring part 122 to the image recognizing unit 130.

Since the first image acquiring part 121 acquires the image information from the laser beam projected on the road surface, the first image acquiring part 121 is implemented by a camera or the like through which only a wavelength of the corresponding laser beam passes. For example, a beam image camera, of which an optical filter capable of transmitting only a wavelength of the corresponding laser beam is attached to a front surface of a 2-D light receiving sensor of a conventional image camera, can serve as the first image acquiring part 121.

Since the second image acquiring part 122 acquires only the same image information as the actual surroundings, the second image acquiring part 122 can be implemented by a conventional camera to which a filter or the like is not applied.

Since the obstacle is detected by comparing the image information simultaneously acquired by the first image acquiring part 121 and the second image acquiring part 122, the first image acquiring part 121 and the second image acquiring part 122 should be positioned adjacent to each other, and should have the same image time. In particular, the first image acquiring part 121 and the second image acquiring part 122 may be implemented as cameras having the same optical characteristics, except for the filter, and may have a synchronization function so that they operate in the same time image frame. As will be described below, since the obstacle detecting system according to an embodiment of the present invention detects the obstacle using optical triangulation, the laser beam scanning unit 110 and the image information acquiring unit 120 should be vertically installed at a predetermined interval. For example, the laser beam scanning unit 110 can be installed at an upper end portion of the vehicle, while the image information acquiring unit 120 can be installed at a lower end portion of a bumper which is provided at the front portion of the vehicle. However, the present invention is not limited thereto.

The image recognizing unit 130 according to one embodiment of the present invention recognizes the shape of the obstacle by performing 3-D image recognition signal processing on the line information of the laser beam using the first image information, and recognizes the pattern of the obstacle by performing pattern recognition processing on the second image information. The image recognizing unit 130 recognizes the actual surroundings, and transmits the recognized information to the risk determining unit 140.

To this end, the image recognizing unit 130 includes a first image signal processing part 131 for transforming the laser beam image signal acquired by the first image acquiring part 121 through the optical triangulation into the 3-D image information, and a second image signal processing part 132 for processing the image signal acquired by the second image acquiring part 122 through the pattern recognition.

The first image signal processing part 131 processes the image acquired by the first image acquiring part 121 through the optical triangulation to acquire the 3-D image information. For example, the first image signal processing part 131 recognizes a shape that is different from a flat road surface to determine the presence of the obstacle, and recognizes the right or left movement of the obstacle.

The first image signal processing part 131 can obtain instant shape information from the image frame acquired by the first image acquiring part 121. More specifically, the first image signal processing part can include information on the position that the laser beam reaches. For example, in a case where the obstacle is at the front, the region of the laser beam projected towards the obstacle reaches the obstacle, while the region of the laser beam projected in a direction away from the obstacle reaches the road surface. The first image signal processing part 131 identifies the reaching position of the laser beam, and then evaluates the linearity of the laser beam. That is, the linearity is evaluated based on the shape formed by the projected laser beam, and the region deviating from the straight line is detected as the obstacle. Accordingly, a 3-D obstacle that exceeds a predetermined profile or flatness of the road surface, for example, road facilities such as a centerline marker, a guardrail, or a traffic lane marker on the road surface, can be recognized in the 3-D shape.

Meanwhile, edges of the road surface can be easily recognized in the same way. For example, precast pavement or a slope of a height different from the road surface can be provided at the edge of the road surface, and desired road facilities can be installed thereon. According to the linearity evaluation of the laser beam as described above, the edges of the road surface can be easily recognized. The first image signal processing part 131 can detect the surroundings of the road surface or the obstacle present at the front through the method. In this instance, a process of determining whether the detected object is a simple profile of the road surface or the obstacle should be executed. This can be executed by determining whether the dimension (e.g., height or width) of the profile detected by the above-described method exceeds a predetermined margin of error or not. That is, if it does not exceed the margin of error, the profile is regarded as the road facilities or a bumpy road. If it exceeds the margin of error, the profile is regarded as the obstacle. At the time of performing the linearity evaluation of the laser beam, it should be determined whether the straight line in question corresponds to the road surface or corresponds to a straight line included in a desired position of the obstacle.

In order to perform such determination, the first image signal processing part 131 sets the point at which the laser beam reaches the road surface in the image acquired by the first image acquiring part 121, and stores it. If the point formed by the laser beam in the straight line is located at the previously set point of the road surface, the straight line in question is determined as the road surface. If it is not the set point, it is determined as a portion of the obstacle. The first image signal processing part 131 performs the processing in succession. If such processing is accumulated, it is possible to find the border (e.g., upper, lower, left, and right positions) of the obstacle or the forming information of the obstacle.

If the first image signal processing part 131 is used, there is an effect of scanning the road surface. That is, it is possible to record the 3-D road shape information by executing the image processing to remove a moving obstacle, such as a vehicle or pedestrian, from the received 3-D road information. Accordingly, the result data similar to a 3-D scanner can be stored by the simple technical configuration.

The beam image data continuously corrected from the driving vehicle can be recorded in the shape of range data that expresses the 3-D image information of the driving road, and the data can be stored in the memory or an external storage device. In this instance, it can have a data architecture connected to GPS (global positioning system) position information of a geographic information system.

The information acquired by the image recognizing unit can be recorded in the memory 160 or a separate storage device in a desired shape (e.g., range data). The stored data is related to the GPS, and thus is utilized as the road shape information of the geographic position.

As described above, the laser beam scanning unit 110 includes two or more laser sources. In this instance, the obstacle detecting function can be further strengthened, and it is possible to accurately find a speed difference between the subject vehicle and the obstacle, or how the obstacle reaches the subject vehicle. For example, if the linearity of the laser beams emitted from the two laser sources is evaluated, it can be determined that obstacles having different heights are present, based on the laser beams emitted from each of the laser sources. In this instance, if the obstacle in question is one object, the slope of the obstacle or the like can be found.

The second image signal processing part 132 performs the obstacle detecting function at the time of recognizing the surroundings, and can utilize a desired pattern recognition algorithm at that time. A digital signal processing technique, such as AdaBoost algorithm proposed by Freund and Schapire, or a support vector machine (SVM) can be utilized as the pattern recognition algorithm. The AdaBoost algorithm is an algorithm for finally detecting an object using images, which are counterexamples of images of the object to be detected. For the operation process of the AdaBoost algorithm, refer to the paper entitled “Rapid object detection using a boosted cascade of simple features,” P. Viloa and M. Jones, of IEEE Computer Society Conference on Computer Vision and Pattern Recognition, Kauai, Hi., 12-14, 2001. In particular, the pattern recognition technology can be applied to recognize pedestrians or other vehicles. In addition, the relative distance between the subject vehicle and the other vehicle can be roughly estimated based on the pixel distance in the obtained image, and the position of the respective obstacles can be traced by recognizing the image frame accumulatively obtained.

The image recognizing unit 130 according to one embodiment of the present invention can receive one or more requirements associated with a target per circumstance from the risk determining unit 140 in real time, in addition to the signal processing, and can transmit different recognition data per circumference to the risk determining unit 140. For example, the image recognizing unit 130 can receive the requirements of detecting obstacles of a specific shape or specific kind only, and can perform the corresponding signal processing.

The risk determining unit 140 according to one embodiment of the present invention classifies the recognized obstacles according to whether the form-recognized obstacle is matched with the pattern-recognized obstacle or not, and determines the possibility of collision. That is, the risk determining unit 140 determines the current risk level based on the information transmitted from the image recognizing unit 130. When the risk level is high, it means the situation in which there is the possibility of collision or the possibility of traffic lane deviation.

In addition, the risk determining unit 140 transmits a signal to request the change of upper and lower scanning angles of the laser beam scanning unit 110 so as to alter the target distance of the laser beam reaching the road surface, or transmits the range data indicating the 3-D road shape information scanned by the subject driving vehicle to the control unit 180 in real time. Furthermore, the risk determining unit 140 can determine the possibility of collision against the road facilities under the road circumference including a straight road and a curved road, by recognizing the presence of various road safety facilities present on the left and right sides of the road based on the driving direction of the subject vehicle.

The first image signal processing part 131 and the second image signal processing part 132 of the image recognizing unit 130 process different image data simultaneously acquired by the first image acquiring part 121 and the second image acquiring part 122. The risk determining unit 140 classifies and determines the risk level based on the data processing result.

First, in the case where an obstacle is not shown in the image obtained by the first image acquiring part 121 through the laser beam scanning, but is shown in the image obtained by the second image acquiring part 122, it may be determined that the obstacle is located beyond the scanning region of the laser beam. That is, since the obstacle is located beyond the target distance, it is determined that the risk level is low.

Second, the obstacle is shown in the image obtained by the first image acquiring part 121 through the laser beam scanning, but is not shown in the image obtained by second image acquiring part 122.

Supposing that the signal processing for the second image data is wrongly performed, a reprocessing signal can be transmitted to the image recognizing unit 130 so that the signal processing for the image data obtained by the second image acquiring part 122 is performed again. If the same result is obtained by the signal reprocessing, the risk determining unit 140 can determine that the obstacle cannot possibly be detected only by processing the image data obtained by the second image acquiring part 122. If a program for recognizing the target obstacle (e.g., a vehicle or a pedestrian) only is installed as the pattern recognizing means, the target obstacle can be determined not as the vehicle or pedestrian which cannot be detected, but as the third obstacle, according to the characteristic restricted to the vehicle or pedestrian only. For example, as the third obstacle, the obstacle may be an object or tree fallen on the road.

Third, in a case where the obstacle is shown on both the image obtained by the first image acquiring part 121 and the image obtained by the second image acquiring part 122 through the laser beam scanning, it can be determined that the obstacle is located in the scanning region of the laser beam, so that the possibility of collision is high. For example, in the whole image data of the beam image camera and the normal image camera which is obtained at the same time or at a similar time within several frames, (x, y) coordinates of a pixel position in the entire image of the obstacle (e.g., a vehicle or pedestrian) recognized by the pattern recognizing technology are compared with (x, y) coordinates of the obstacle recognized by the signal processing of the laser beam, and the obstacle which is overlapped and recognized within the margin of error can be recognized as the same target object.

The risk determining unit 140 classifies the obstacles recognized according to whether the form-recognized obstacle is matched with the pattern-recognized obstacle or not, and then determines whether the obstacle is within the target distance, thereby determining the possibility of collision. Accordingly, it is possible to improve the precision of obstacle detection by minimizing the determination error. The target distance may be a stationary target distance based on the concept of an average driving speed, or a variable target distance per driving speed.

The risk determining unit 140 can determine whether the subject vehicle drives along a straight road or curved road through the pattern-recognized driving traffic lane, and determine whether the recognized obstacle is on the same traffic lane as the subject vehicle or an adjacent traffic lane. Accordingly, the risk determining unit 140 can quickly and accurately determine whether the obstacle is overlapped and recognized on the same time image frame from two different cameras whether the recognized obstacle is on the recognized driving traffic lane, or whether the recognized obstacle is within the safety distance, through the simple data process.

The risk determining unit 140 can determine the risk level by connecting the signal processing result by the first image signal processing part 131 and the signal processing result by the second image signal processing part 132 in a dependent structure. For example, it can be determined in such a way that the normal image recognizing result is regarded as master recognition and the beam image recognizing result is regarded as slave recognition. Alternatively, it can determine the risk level by connecting the beam image recognizing result and the normal image recognizing result in a parallel structure.

Meanwhile, it can determine the risk level by applying a different weighted value to the signal processing result by the first image signal processing part 131 and the signal processing result by the second image signal processing part 132. For example, in a case where a higher weighted value is applied to the signal processing result by the first image signal processing part 131, only the obstacle shown in the signal processing result by the first image signal processing part 131 can be determined as a more dangerous obstacle than the obstacle shown in the signal processing result by the second image signal processing part 132. For example, a median barrier or median facility recognized by the laser line beam is determined as an important facility and thus is applied with the weighted value, so that it is used to determine the collision risk. The efficiency in the determination of the collision risk or the traffic lane deviation can be maximized. In addition, it is possible to determine whether the recognized obstacle is the same obstacle or not by tracing the position of the pixel of the obstacle present in the image on the basis of the signal processing results accumulated with the time, or the signal processing result of the adjacent time.

The risk determining unit 140 according to one embodiment of the present invention can determine the movement or driving speed of the detected obstacle. More specifically, the risk determining unit 140 receives the information on the current driving speed of the vehicle from a speed detecting sensor built in the vehicle, determines the position variation in the image of the obstacle based on the image signal processing results accumulated with the time, and then measures the relative driving speed of the obstacle with respect to the vehicle, thereby identifying the absolute driving speed and the moving direction of the obstacle. The risk determining unit 140 can classify the collision risk in phases by measuring the size or moving speed of the obstacle, or the distance between the subject vehicle and the obstacle. For example, if variables for the size or moving speed of the obstacle, or the distance between the subject vehicle and the obstacle are classified in a predetermined range and a predetermined weighted value is set for each variable, the risk can be determined in phases. That is, if the size of the obstacle is same but the moving speed is relatively fast, it is determined that the obstacle in question is more dangerous than the obstacle of which the moving speed is slow.

The risk determining unit 140 according to one embodiment of the present invention can predict the driving direction of the vehicle, and then determine the risk of the road deviation and the risk of collision based on the predicted result. The driving direction of the vehicle is determined by receiving the information on a control angle of a steering device built in the vehicle, and thus a future driving direction can be predicted based on the determined driving direction. In addition, the driving direction of the vehicle can be determined by applying the pattern recognizing technology to the image acquired by the second image acquiring part 122. For example, the moving direction of the object relative to the vehicle can be measured by tracing the object through an optical flow method, and the driving direction of the vehicle can be determined using the information to the contrary. If the driving direction of the vehicle is predicted, it is possible to find the obstacle positioned within the predicted driving direction of the vehicle, and the obstacle deviating from the predicted driving direction based on the predicted driving direction, thereby determining detailed physical parameters. In addition, it is possible to classify and determine the risk of the road deviation and the risk of collision through the prediction of the driving direction. More specifically, the image recognizing unit 130 determines the edges of the road surface as described above. If the driving direction predicted based on the result faces the edge of the road surface, it is determined that there is the risk of the road deviation. If the detected obstacle is located in the predicted driving direction, it is determined that there is the risk of collision.

The risk determining unit 140 according to one embodiment of the present invention quickly determines various kinds of information based on the image information obtained by the first image acquiring part 121 within the range scanned by the laser beam, and the image information obtained by the second image acquiring part 122 for the whole region, thereby effectively determining the risk of the road deviation and the risk of collision. In addition, since the risk of the road deviation and the risk of collision are classified and determined, and each risk is determined in phases, it is possible to handle the obstacle according to the circumstances.

The input unit 150 according to one embodiment of the present invention is manipulated by the user so that the user directly inputs commands to operate the overall system 100 or the respective components included in the system 100. The input unit 150 can be implemented by a conventional means such as a keypad, a touch screen or a tablet, and includes an interface to allow the user to easily input the commands.

The memory 160 according to one embodiment of the present invention stores the results processed by the image recognizing unit 130, or the data transmitted from the risk determining unit 140 to the control unit 180 in real time. The memory 160 can transmit and receive the data to and from the control unit 180, and includes an external auxiliary storage device such as a hard disk drive (HDD). The memory 160 can store the 3-D road image data generated by the image recognizing unit 130 as a predetermined form in a relation corresponding to the position information of GPS. The stored information can be utilized at the time of implementing an automatic driving function of the vehicle, and can provide the information on the corresponding position in the 3-D image when the geographic information is supplied to the user in connection with a navigation appliance.

The control unit 180 according to one embodiment of the present invention adjusts the intensity or scanning angle of the laser beam scanned from the laser beam scanning unit 110 according to the target distance. In addition, the control unit 180 transmits the control signal to the external control device or safety device 170 according to the determined result of the risk determining unit 140, thereby preventing the vehicle from colliding against the obstacle or deviating from the road.

The external device 170 may be an external control device or safety device. For example, the external device 170 includes a steering device control unit (electronic control unit; ECU), a brake device control unit, an airbag control unit, a safety belt control unit, a driver alarm device control unit, and a display control unit. For example, if the control unit 140 receives the information on the determination of collision risk from the risk determining unit 140, the control unit 140 generates and transmits the signal to control the alarm device control unit so as to notify the driver of the risk alarm. Since the risk determining unit 140 classifies the risk of the road deviation and the risk of the collision and determines each risk in phases, different control signals can be generated according to each case. For example, when there is the risk of collision, a control signal to operate the alarm device, the brake device or the airbag can be generated. When there is the risk of the road deviation, a control signal to operate the alarm device and the brake device only can be generated. In addition, when the risk of collision is classified in phases and there is the risk of a higher phase, a control signal to sound a relatively loud alarm or a control signal to operate the airbag can be generated. The control unit 180 supplies the speed information received from the speed detecting sensor of the vehicle to the risk determining unit 140 so as to allow the risk determining unit 140 to accurately determine the risk of collision. The control unit 180 has a role of controlling the flow of data between the respective components in the system 100 or each component and the external device, and controlling an inherent function of the respective elements.

The process of detecting the obstacle according to one embodiment of the present invention will now be described.

<Process of Detecting Obstacle>

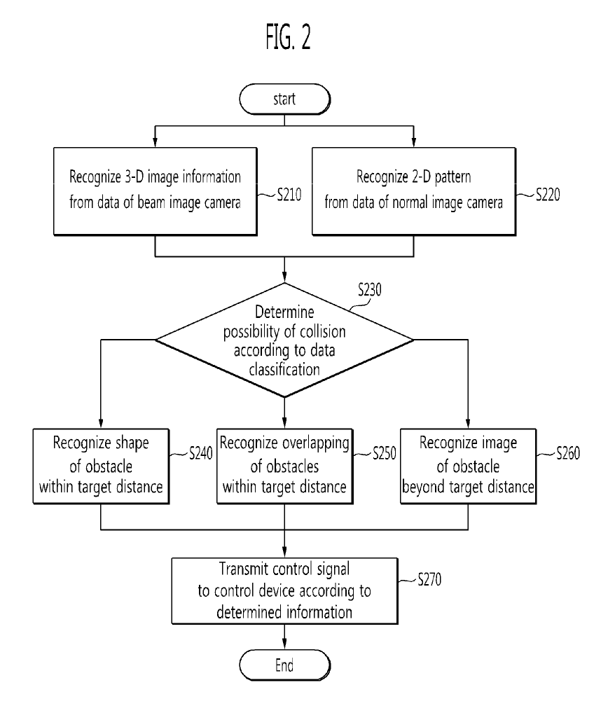

FIG. 2 is a flowchart illustrating the process of detecting the obstacle according to one embodiment of the present invention.

First, if the laser beam is scanned by the laser beam scanning unit 110, the first image acquiring part 121 of the image information acquiring unit 120 acquires the shape projected by the laser beam as the image information, and the second image acquiring part 122 acquires the image information on the actual surroundings.

The image recognizing unit 130 recognizes the shape of the obstacle from the image data received by the first image acquiring part 121, for example, the beam image camera. More specifically, the image recognizing unit 130 identifies the presence of the obstacle in the target distance based on the optical triangulation, determines whether the obstacle moves in the left or right direction, and transmits the data indicating the time information of the image frame of the shape-recognized obstacle and the target distance of the laser line beam to the risk determining unit 140 (S210).

The image recognizing unit 130 performs the pattern recognizing process of the images received by the second image acquiring part 122, for example, the normal image camera 222, to recognize the obstacle representative of the vehicle or the pedestrian. Simultaneously, the image recognizing unit 130 performs the pattern recognition so as to recognize the driving traffic lane of the subject vehicle, and transmits the results to the risk determining unit 140 (S220).

The risk determining unit 140 classifies the recognized obstacles according to whether the shape-recognized obstacle and the pattern-recognized obstacle are matched with each other, and determines the possibility of collision (S230). In this instance, after it is determined whether the recognized obstacle is the overlapped obstacle, the obstacles are classified into at least two kinds so as to prevent the collision. In order to quickly and accurately classify the data, properties of the obstacle shape recognizing data in operation S210 may be used. In addition, it is determined whether the obstacle in question is on the same driving traffic lane as the subject vehicle or is outside of the traffic lane, by connecting the traffic lane recognizing result of operation S220 and the position information result of the recognized obstacle, and then the classification is performed for the obstacles on the driving traffic lane.

According to the present invention, the recognized obstacles are classified into three phases.

First, it is determined that the pattern-recognized obstacle which is not matched with the shape-recognized obstacle is located beyond the target distance, and thus the risk level is low. Second, the shape-recognized obstacle which is not matched with the pattern-recognized obstacle is located within the target distance, but it is highly possible that the obstacle is not previously predicted. In addition, since it is an error in the signal processing, it is preferable to reprocess the image signal. Third, the shape-recognized obstacle which is matched with the pattern-recognized obstacle is located within the target distance, and thus it is determined that the risk level is high. Therefore, it is highly possible that the kind of the recognized obstacle is the front vehicle or the pedestrian.

The risk determining unit 140 transmits three kinds of the determined results to the control unit 180 (S240, S250 and S260).

The control unit 180 generates and transmits the control signal to control the driver alarm device, the safety belt, the airbag, the brake device, and the steering device according to the determined results received from the risk determining unit 140, so that the driving vehicle does not collide with the obstacle (S270). In operation S270, it is possible to control the scanning angle of the laser line beam, which is adjusted to the target distance and the optimum signal size so that the laser beam scanning unit 110 operates normally. The control unit 180 can be supplied with an input signal from the driver input unit 150 so that the respective control devices are selectively and automatically operated according to requirements for vehicle driving and risk management of a user. The control unit 180 stores the information on the road shape obtained by the laser line beam in the memory 160.

An example of the obstacle detecting system according to one embodiment of the present invention will now be described.

### EXAMPLES

FIG. 3 is a diagram illustrating one example of the obstacle detecting system 100 according to one embodiment of the present invention which is applied to a vehicle.

As shown in FIG. 3, the vehicle driving on the road surface with a traffic lane 310 is provided with the laser beam scanning unit 110 at the upper end thereof, and the image information acquiring unit 120 at a relatively lower position (e.g., a lower portion of the bumper formed at the front surface of the vehicle). The laser beam emitted from the laser beam scanning unit 110 can be scanned at a slope on the road surface in front of the vehicle. The first image acquiring part 121 of the image information acquiring unit 120 is installed to capture the whole range B including the region A on which the laser beam is projected.

If the distance d from the point to which the laser beam reaches to the front line of the vehicle is known, it is possible to determine the distance between the obstacle and the vehicle when the obstacle is detected. The distance d can be calculated by the height from the ground on which the laser beam scanning unit 110 is installed and the scanning angle of the laser beam, or can be calculated in advance by a direct measuring method. If the distance d is set as the minimum safety distance, the maintenance of the safety distance from the front vehicle can be identified in real time, thereby securing the safety distance.

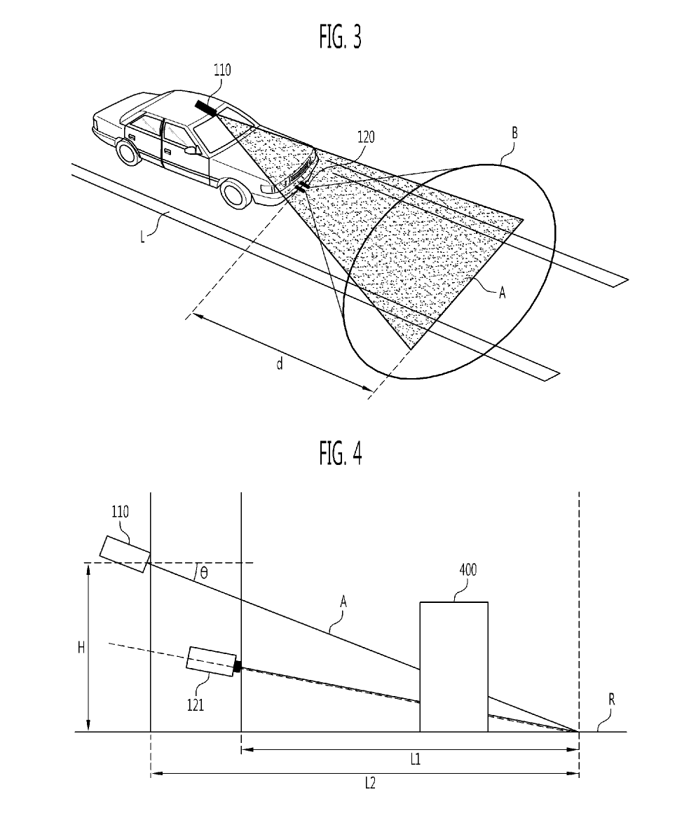

FIG. 4 is a cross-sectional view taken along a straight line passing through a central portion of a vehicle which is parallel to the traffic lane 310 in FIG. 3.

The camera focus of the first image acquiring part 121 which is provided in the image information acquiring unit 120 is set so that it is formed at the same point as the point in which the region A covered by the laser beam projected by the laser beam scanning unit 110 meets the road surface R. As shown in FIG. 4, an obstacle 400 may be present on the road. In this instance, a portion of the laser beam projected from the laser beam scanning unit 110 reaches the obstacle 400, and the remaining portion reaches the road surface R. It is assumed that the obstacle 400 shown in FIG. 4 is cylindrical.

Among the scanning angle θ of which the scanning direction of the laser line beam is slant to the reference of the road surface, the height H between the laser line beam and the road surface, and the distance L from a vertical point of the laser line beam to the point at which the laser line beam reaches the road surface, the scanning angle θ and the height H are already known, and thus the distance L2 can be calculated on the principle of a trigonometric function. At the same time, the distance between the obstacle and the subject vehicle can be approximately calculated by a proportional principle of a triangle. In a case where the first image acquiring part 121 is provided at the front line of the subject vehicle, the distance L1 between the subject vehicle and the point at which the laser beam line reaches the road surface is separately calculated, and then is utilized as the determination reference for collision prevention.

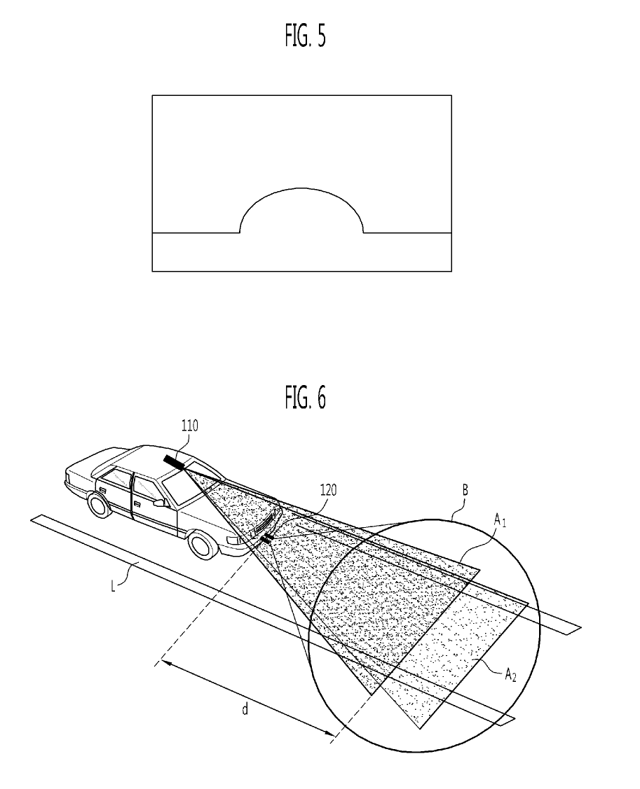

FIG. 5 is a diagram illustrating only the image of the projected laser beam among the images acquired by the first image acquiring unit 121 in the example of FIG. 4.

The laser beam projected by the laser beam scanning unit 110 is a horizontal linear laser beam, and the obstacle 400 is cylindrical. Since the first image acquiring part 121 is installed at the position, which is relatively lower than the laser beam scanning unit 110, a portion of the laser beam reaches the surface of the cylindrical obstacle, and the remaining portion reaches the road surface R. Accordingly, the shape of the laser beam is similar to that in FIG. 5.

The image recognizing unit 130 can recognize that the cylindrical obstacle 400 is present in the monitoring region scanned by the laser beam, and the obstacle 400 is located at the center portion of the monitoring region, on the basis of the acquired image.

The image recognizing unit 130 can determine that the straight portion is the road surface R from the image in FIG. 5, but can accurately determine whether the straight portion is the road surface R, by comparing the image with the image data when only the road surface R is captured, that is, the image data in which no obstacle is present. In addition, if the distance between the uppermost portion of the portion indicated by a curved line and the straight portion determined as the road surface R is measured, the proximity distance between the obstacle 400 and the vehicle can be computed by the optical triangulation.

The whole road should be scanned by the laser beam so as to correct the 3-D image data for the road. According to the present invention, since the information on the driving speed of the vehicle is obtained from the speed detecting sensor, the whole scanned pattern of the road surface is obtained from the projected images of the laser beam which are accumulated in consideration of the driving speed of the vehicle. Accordingly, it is possible to collect the information on the 3-D road shape.

FIG. 6 is a diagram illustrating one example of the obstacle detecting system 100 according to one embodiment of the present invention, which is applied to the vehicle. In the example shown in FIG. 6, the laser beam scanning unit 110 includes two laser beam sources.

Referring to FIG. 6, since the laser beams are scanned from two laser beam sources which are provided at different heights or have different beam scanning angles, different laser beam projected regions A₁ and A₂ are formed, and the positions to which the laser beams projected from each light source reach the road surface are different.

If the plurality of laser sources are utilized, different laser beam projected regions, that is, the monitoring regions, can be obtained, so that the risk level can be identified in the unit of the monitoring region. The moment at which the obstacle is detected for each monitoring region is identified, and thus the information (e.g., the direction or velocity) on the movement of the obstacle can be obtained from the identified moment. As described above, if the linearity of the laser beams scanned from the plurality of laser sources is evaluated, it is possible to determine the slope angle of the detected obstacle or movement of the obstacle toward the slope direction. As compared with the case in which one laser source is utilized, it is possible to accurately identify the moving information of the vehicle, the information on the road surface, or the information on the obstacle.

According to the present invention, it is possible to quickly and effectively determine an obstacle, which exists within a forward target distance of a driving vehicle, by obtaining 3-D image information based on image information on a projection shape of a laser beam, and obtaining 2-D image information on actual surroundings to identify movement of the obstacle and effectively detect or prevent a collision risk or traffic lane deviation risk. In particular, it is possible to simply and quickly recognize the obstacle at a target distance point in front of the subject vehicle by using the 3-D image information, and to determine whether or not the obstacle exists within the target distance by using the 2-D image information.

In the drawings and specification, there have been disclosed typical exemplary embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. An obstacle detecting system comprising:
a first image acquiring unit which acquires first image information by selectively receiving a laser beam emitted from at least one laser source toward a road surface at a target distance;
a second image acquiring unit which acquires an image of actual surroundings as second image information;
an image recognizing unit which recognizes an image of an obstacle by performing 3-D image recognition signal processing on line information of the laser beam using the first image information, and recognizes a pattern of the obstacle by performing pattern recognition signal processing on the second image information; and
a risk determining unit which classifies the recognized obstacles according to whether or not the image-recognized obstacle is matched with the pattern-recognized obstacle, and determines a possibility of collision due to presence of the obstacle within the target distance.

2. The obstacle detecting system of claim 1, wherein the image recognizing unit recognizes that the shape-recognized obstacle relatively moves in a left or right direction on the basis of a driving direction of a subject vehicle, and
the risk determining unit determines possibility of collision according to the movement of the shape-recognized obstacle.

3. The obstacle detecting system of claim 1, wherein the image recognizing unit recognizes a pattern of a driving traffic lane of a subject vehicle by performing the pattern recognition signal processing on the second image information, and
the risk determining unit compares the pattern recognizing result of the driving traffic lane and position information of the pattern-recognized obstacle, extracts the obstacle in the driving traffic lane, and classifies the extracted obstacle.

4. The obstacle detecting system of claim 1, wherein the risk determining unit determines that if the shape-recognized obstacle is matched with the pattern-recognized obstacle, the obstacle is located within the target distance, and the possibility of collision is high, and that if the shape-recognized obstacle is not matched with the pattern-recognized obstacle, the obstacle is located beyond the target distance, and the possibility of collision is low.

5. The obstacle detecting system of claim 1, wherein when the shape-recognized obstacle is not matched with the pattern-recognized obstacle, the image recognizing unit again performs the signal processing on image data obtained from the second image acquiring unit.

6. The obstacle detecting system of claim 1, further comprising a control unit which adjusts a scanning angle of the laser beam to the road surface according to the target distance, and transmits a control signal to an external control device or a safety device according to the determined result of the risk determining unit.

7. The obstacle detecting system of claim 1, wherein the image recognizing unit includes a first image signal processing part for recognizing information on whether the obstacle is within the target distance, and a position, shape, driving direction or driving velocity of the obstacle, from the first image information, and a second image signal processing part for performing pattern recognizing algorithm processing on the second image information.

8. The obstacle detecting system of claim 7, wherein the laser beam is a horizontal linear beam, and the first image signal processing part recognizes the information on the object using linearity evaluation on a projected shape of the laser beam or optical triangulation.

9. The obstacle detecting system of claim 8, wherein the first image signal processing unit recognizes an object within the target distance from the first image information, and classifies the object as a facility, a profile, or an obstacle according to a level in which the projecting shape of the laser beam deviates from a straight line.

10. An obstacle detecting method comprising:
scanning a laser beam on a road surface at a target distance from at least one laser source;
selectively receiving the laser beam only to acquire first image information;
acquiring an image of actual surroundings as second image information;
recognizing a shape of the obstacle by performing 3-D image recognition signal processing on line information of the laser beam using the first image information;
recognizing a pattern of the obstacle by performing pattern recognition signal processing on the second image information to;
classifying the recognized obstacles by identifying the image-recognized obstacle is matched with the pattern-recognized obstacle or not; and
determining a possibility of collision by identifying the obstacle is within the target distance or not, based on the classified result.

11. The obstacle detecting method of claim 10, wherein the recognizing a shape of the obstacle recognizes the shape-recognized obstacle relatively moves in a left or right direction on the basis of a driving direction of a subject vehicle, and
wherein the determining a possibility of collision determines the possibility of collision according to movement of the shape-recognized obstacle.

12. The obstacle detecting method of claim 10, wherein the recognizing a pattern of the obstacle recognizes a pattern of a driving traffic lane of a subject vehicle by performing the pattern recognition signal processing on the second image information, and
wherein the classifying the recognized obstacles comparing the pattern recognizing result of the driving traffic lane with position information of the shape-recognized or pattern-recognized obstacle, extracts the obstacle in the driving traffic lane, and classifies the extracted obstacle.

13. The obstacle detecting method of claim 10, wherein the determining a possibility of collision determines that if the shape-recognized obstacle is matched with the pattern-recognized obstacle, the obstacle is located within the target distance, and the possibility of collision is high.

14. The obstacle detecting method of claim 10, wherein if the shape-recognized obstacle is not matched with the pattern-recognized obstacle, the recognizing a pattern of the obstacle is performed again.

15. The obstacle detecting method of claim 10, wherein the determining a possibility of collision determines that if the shape-recognized obstacle is not matched with the pattern-recognized obstacle, the obstacle is located beyond the target distance, and the possibility of collision is low.

16. The obstacle detecting method of claim 10, wherein the determining a possibility of collision determines that if the object detected as the result of recognizing the second image information is not included in the first image information, the detected object is located beyond a region which is scanned by the laser beam.

17. The obstacle detecting method of claim 10, further comprising adjusting a scanning angle of the laser beam to the road surface according to the target distance, before the laser beam scanning operation.

18. The obstacle detecting method of claim 10, further comprising transmitting a control signal to an external control device or a safety device according to the possibility of collision, after the determining a possibility of collision.
